(19) United States
(12) Patent Application Publication
(10) Pub. No.: US 2008/0275169 A1
(43) Pub. Date: Nov. 6, 2008

(54) Universal Pigment Preparations

(75) Inventors: Andreas Wenning, Nottuln (DE); Dietmar Loest, Duelmen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/908,291

(22) PCT Filed: Jan. 25, 2006
(86) PCT No.: PCT/EP2006/050437

§ 371 Date: Sep. 11, 2007

(30) Foreign Application Priority Data
Mar. 17, 2005 (DE) 10 2005 012 316.3

(51) Int. Cl. C08L 53/00; C08K 5/3412; C08K 3/22; C08K 5/23; C08K 5/36; C08K 5/5435; C08K 5/00; C08K 5/109; C08K 5/34; C08K 5/08; C08K 5/20; C08K 5/1545

(52) U.S. Cl. 524/88; 524/505; 524/394; 524/110; 524/210; 524/431; 524/190; 524/358; 524/392; 524/90; 524/96; 524/321; 524/80

(57) ABSTRACT

The invention relates to new universal pigment preparations as virtually foam-free aqueous and also solventborne and solvent-free pigment preparations and to their use in aqueous, solventborne or solvent-free coating materials such as paints, varnishes, adhesives or inks, including printing inks, for example.

The invention relates to new universal pigment preparations as virtually foam-free aqueous and also solventborne and solvent-free pigment preparations and to their use in aqueous, solventborne or solvent-free coating materials such as paints, varnishes, adhesives or inks, including printing inks, for example.

For dispersing fillers and pigments in liquid media it is usual to make use of dispersants, in order in this way to reduce the mechanical shearing forces that are needed for effective dispersion of the solids, and at the same time to realise very high filling levels. The dispersants assist the disruption of agglomerates, wet and/or coat, as surface-active compounds, the surface of the particles to be dispersed, and stabilize them against unwanted reagglomeration.

During the preparation of inks and varnishes, wetting agents and dispersants facilitate the incorporation of pigments and fillers, which, as important formulating ingredients, significantly determine the visual appearance and the physicochemical properties of coatings. For optimum utilization, on the one hand, these solids must be dispersed uniformly in coatings and inks, and on the other hand the state of dispersion, once attained, must be stabilized. The stabilizing component is in many cases also represented by binder components. Binder components of this kind are valuable components of coating materials not least on account of their contribution to more rapid drying and to increasing the hardness of the resultant films.

Of importance for application in universal pigment preparations is firstly a universal compatibility with other binders, such as with the important long-oil alkyd resins, vegetable oils, hydrocarbon resins, acrylate resins, and polyamides, and secondly a universal solubility in organic solvents, such as in the pure aliphatics and white spirits that are frequently employed on environmental and toxicological reasons. Binders of this kind which can be used in pigment preparations and have universal compatibility and solubility are described for example in DE 44 04 809.

Dispersants used for universal pigment preparations, are, in particular, alkylphenol ethoxylates or fatty alcohol alkoxylates, which contribute to steric stabilization of states of pigment dispersion that have been attained. The alkylphenol ethoxylates, though giving very high performance, have come under criticism on ecotoxicological reasons. Their use in detergents and cleaning products is already banned in many countries. Similar strictures can be expected for the paints and coatings industry. Fatty alcohol ethoxylates in many cases fail to achieve the good pigment wetting properties of the alkylphenol ethoxylates, since they lack groups capable of adsorption. The nonadsorbed part of this product group, in particular, also has the undesirable effect of stabilizing the foam in aqueous pigment preparations.

Block-copolymeric polyalkylene oxides are toxicologically unobjectionable, highly adsorptive, but not very stabilizing with regard to foam. They are described for example in EP 1 078 946. Complete breakdown of foam formation, however, is something which these products cannot achieve. Here as well, therefore, active defoaming substances must be added to the aqueous pigment preparations. These substances, however, have other, negative side-effects, such as unwanted surface defects. Many dispersing additives cannot be used because the water resistance or light stability of coatings is adversely affected.

It was an object of the present invention, therefore, to find pigment preparations for which there is broad compatibility with binders used and solubility in organic solvents and water used, and where also the formation of foam in aqueous pigment preparations ought to be suppressed.

The object on which the invention is based has been surprisingly achieved through the use of a combination of block-copolymeric, styrene oxide-containing polyalkylene oxides and ketone-aldehyde resins.

Surprisingly it has been found that the combination of block-copolymeric, styrene oxide-containing polyalkylene oxides with ketone-aldehyde resins is outstandingly suitable for use as a dispersant not only for solvent-free but also solvent-borne and aqueous universal pigment preparations.

A broad compatibility with binders and solubility in organic solvents and water used for universal pigment preparations has been found. Furthermore, foam formation in aqueous pigment—preparations is very efficiently suppressed. The properties of coating materials, such as initial drying and hardness, are positively influenced when they contain the pigment preparations of the invention. In knowledge of the state of the art it could not have been foreseen that the combination of the individual components would lead to the composition possessing the stated sum of properties.

The invention provides aqueous, solventborne or solvent-free pigment preparation essentially containing compositions comprising
A) 95% to 5% by weight of at least one block-copolymeric, styrene oxide-containing polyalkylene oxide,
   and
B) 5% to 95% by weight of a ketone-aldehyde resin,
   and
C) 0 to 80% by weight of at least one solvent, the sum of the amounts by weight of components A) to C) being 100% by weight,
   and
D) pigments
   and
E) fillers,
   and
F) 0 to 10% by weight of auxiliaries,
   the amount of the sum of component A), component B), and component C) being 2%-300% by weight, based on the sum of the weights of the respective components D) and E), and it being possible for the amount of component E) in the pigment preparation also to be 0% by weight.

Since not only block-copolymeric, styrene oxide-containing polyalkylene oxides but also ketone-aldehyde resins are insoluble in water, it was completely surprising that a combination of both compounds is soluble in water and allows use in aqueous pigment preparations.

In principle, all block-copolymeric, styrene oxide-containing polyalkylene oxides are suitable as component A).

The block-copolymeric, styrene oxide-containing polyalkylene oxides A) used with preference in the invention are described for example in EP 1 078 946. They possess the general formula I:

R¹O(SO)ₐ(EO)_{b}(PO)_{c}(BO)_{d}R²,

where R¹ is a straight-chain or branched or cycloaliphatic radical having 8 to 13 carbon atoms,
R² is hydrogen or an acryloyl radical, alkyl radical or carboxylic acid radical having in each case 1 to 8 carbon atoms,
SO=styrene oxide,
EO=ethylene oxide,
PO=propylene oxide,
BO=butylene oxide and
a=1 to 1.9,
b=3 to 50,
c=0 to 3,
d=0 to 3,
a, c or d being other than 0, and b>=a+c+d.

In principle, all ketone-aldehyde resins are suitable as component B).

The preferred ketone-aldehyde resins B), which are described in DE 44 05 809, are prepared from cycloaliphatic ketones, aldehyde, and, if desired, further monomers.

These ketone-aldehyde resins contain
I. 40 to 100 mol %, based on all ketones employed, of at least one alkyl-substituted cyclohexanone having one or more alkyl radicals having 1 to 8 carbon atoms,
II. 0.8 to 2.0 mol of at least one aliphatic aldehyde, based on 1 mol of all ketones employed, and
III. 0 to 60 mol %, based on all ketones employed, of further ketones having aliphatic, cycloaliphatic, aromatic hydrocarbon radicals, it being possible for these ketones to be identical or different and to be substituted in turn, in the hydrocarbon chain, by the stated hydrocarbon radicals, and also, if desired, phenols and/or urea or its derivatives.

Particularly preferred C₁- to C₈-alkyl-substituted cyclohexanones are 4-tert-butylcyclohexanone and 3,3,5-trimethylcyclohexanone.

The mixing ratio of the block-copolymeric, styrene oxide-containing polyalkylene oxides to the ketone-aldehyde resins, used in accordance with the invention, is 95:5 to 5:95. If more than 50% by weight of ketone-aldehyde resin is used in this mixture, an auxiliary solvent C) must be used, for viscosity reasons.

Suitable components C) include water and all organic solvents. The organic solvents include, for example, alcohols, esters, ketones, ethers, glycol ethers, aromatic hydrocarbons, hydroaromatic hydrocarbons, halogenated hydrocarbons, terpene hydrocarbons, aliphatic hydrocarbons, ester alcohols, dimethylformamide or dimethyl sulfoxide.

For solventborne pigment preparations preference is given to organic solvents which are environmentally and toxicologically unobjectionable and which are miscible or compatible to a certain degree with water.

For aqueous pigment preparations the mixture of block-copolymeric, styrene oxide-containing polyalkylene oxides A) and ketone-aldehyde resins B) is preferably chosen so that there is no need for an organic solvent as component C).

As component D) it is possible for example to use organic or inorganic pigments and also carbon blacks.

Examples that may be mentioned of inorganic pigments contain titanium dioxides and iron oxides.

Examples of suitable organic pigments are azo pigments, metal complex pigments, anthraquinonoid pigments, phthalocyanine pigments, polycyclic pigments, especially those of the thioindigo, quinacridone, dioxazine, pyrrolo, naphthalenetetracarboxylic acid, perylene, isoamidolin(on)e, flavanthrone, pyranthrone or isoviolanthrone series.

As carbon blacks, gas blacks, lamp blacks or furnace blacks can be used. These carbon blacks may additionally have been reoxidized and/or beaded.

Besides pigments, fillers, too, may also be used as component E). They are mostly pulverulent substances which are virtually insoluble in the application medium. They are obtained predominantly from naturally occurring minerals by breakdown, purification, milling, and subsequent classification into particle fractions. Additionally, however, synthetic products, such as sulfates or carbonates, are used as fillers if, for example, cleanness (lightness) or particularly fine division are factors of importance. Unlike pigments, fillers generally possess a low opacity. Besides increasing the volume (making the formulation less expensive), they exhibit highly specific activities in the film, such as reflection, surface texture, abrasion resistance or stone-chip resistance, for example. Their use is predetermined by their particle size, particle size distribution, particle morphology, particle structure, hardness, density, color, wettability, abrasiveness, surface adsorption, refractive index, chemical composition, purity, stability, and price. The interactions which exist in the binder/filler area must be taken into account in each individual case. Determining the optimum amount of filler, however, is commonplace to a skilled worker. Fillers are used generally at 0 to 95% by weight, based on the pigment.

Examples of fillers which can be dispersed in aqueous and/or solventborne coating materials are those based on kaolin, talc, mica, other silicates, quartz, cristobalite, wollastonite, perlites, diatomaceous earth, fiber fillers, aluminum hydroxide, barium sulfate or calcium carbonate.

As component F) it is possible to use all auxiliaries known to the skilled worker for pigment preparations. These include, for example, defoamers, devolatilizers, rheological assistants, surface additives, which influence lubricity, scratch resistance, antiblocking, flow, and gloss, for example, substrate wetting additives, or biocides.

The invention also provides a process for preparing aqueous, solventborne or solvent-free pigment preparations essentially containing compositions comprising
A) 95% to 5% by weight of at least one block-copolymeric, styrene oxide-containing polyalkylene oxide,
   and
B) 5% to 95% by weight of a ketone-aldehyde resin,
   and
C) 0 to 80% by weight of at least one solvent,
   the sum of the amounts by weight of components A) to C) being 100% by weight,
   and
D) pigments
   and
E) fillers,
   and
F) 0 to 10% by weight of auxiliaries,
   the amount of the sum of component A), component B), and component C) being 2%-300% by weight, based on the sum of the weights of the respective components D) and E), and it being possible for the amount of component E) in the pigment preparation also to be 0% by weight,
   by mixing compounds A), B) C), D), E) and F) at temperatures from 20 to 80° C. in a Dispermat, Skandex mixer, Red Devil, single-roll mill, triple-roll mill, beadmill or other suitable assembly.

In the context of its use in accordance with the invention, the mixture of block-copolymeric, styrene oxide-containing polalkylene oxides and ketone-aldehyde resins can either be mixed beforehand with the pigments that are to be dispersed, or dissolved directly in the aqueous or solvent-containing dispersing medium, prior to or simultaneously with the addition of the pigments.

The pigment preparations of the invention are used in coating materials, such as in paints, varnishes, adhesives, and printing inks, for example.

The invention therefore also provides for the use of aqueous, solventborne or solvent-free pigment preparations essentially containing compositions comprising
A) 95% to 5% by weight of at least one block-copolymeric, styrene oxide-containing polyalkylene oxide,
   and
B) 5% to 95% by weight of a ketone-aldehyde resin,
   and
C) 0 to 80% by weight of at least one solvent,
   the sum of the amounts by weight of components A) to C) being 100% by weight,
   and
D) pigments
   and
E) fillers,
   and
F) 0 to 10% by weight of auxiliaries,
   the amount of the sum of component A), component B), and component C) being 2%-300% by weight, based on the sum of the weights of the respective components D) and E), and it being possible for the amount of component E) in the pigment preparation to be 0% by weight,
   in coating materials.

As coating materials in which the pigment preparations of the invention can be preferentially introduced, suitability is possessed by all aqueous, solventborne or solvent-free systems that are known to the skilled worker. These systems may, for example, be physically drying, oxidatively drying or -reactive otherwise in 1K (one-component) or 2K (two-component) coatings.

There is a multiplicity of physically drying resins, examples being nitrocellulose, polyvinylbutyral, VC copolymers, acrylates, methacrylates, cellulose esters, cellulose ethers, hydrocarbon resins, phenolic resins, rosins, maleate resins, polystyrene resins, silicone resins, rubber-based film-forming resins such as cyclorubber, chlororubber, chlorinated polyolefins or oligobutadienes, polyolefins, polyvinyl esters, polyvinyl alcohols, polyvinylacetals, epoxides, amino resins, amido resins, and polyester resins. Oxidatively drying coating materials are, for example, alkyd resins. 1K coating materials are based for example on acrylate, epoxy, polyvinyl acetate, polyester or polyurethane resins. Other 1K coating materials are based on hydroxyl-containing polyacrylate or polyester resins with melamine resins or blocked polyisocyanate resins as crosslinkers. 2K coating materials are those, for example, based on polyepoxide systems or on hydroxyl-containing polyacrylate or polyester resins with nonblocked polyisocyanate resins as crosslinkers.

The compositions of the invention are notable for very good adsorptivity to pigments, excellent foam destruction, and a low viscosity. Furthermore, the drying rate, water resistance and chemical resistance, and hardness of the coatings are positively influenced.

The following examples are intended to illustrate the invention but not restrict its scope of application:

### EXAMPLES

### 1) Preparation of a Styrene Oxide-Containing Polyalkylene Oxide (not Inventive)

336.4 g (2.34 mol) of trimethylcyclohexanol and 16.3 g (0.23 mol) of potassium methoxide were charged to a reactor. After careful flushing with pure nitrogen, the initial charge was heated to 110° C. and 308.2 g (2.554 mol) of styrene oxide were added over the course of an hour. After a further two hours the addition of the styrene oxide was at an end, as evidenced by a residual styrene oxide content of <0.1% by weight according to gas chromatogram. Subsequently 339.2 g (7.71 mol) of ethylene oxide were metered into the reactor at a rate such that the internal temperature did not exceed 120° C. and the pressure did not exceed 6 bar. Following complete introduction of the ethylene oxide, the temperature was held at 115° C. until a constant manometer pressure indicated the end of the subsequent reaction. Lastly, at 80 to 90° C., the unreacted, residual monomers were removed under reduced pressure. The product obtained was neutralized with the aid of phosphoric acid, and the water was removed by distillation and the potassium phosphate formed by filtration together with a filter aid. The molecular weight from the determination of the hydroxyl number, with an assumed functionality of 1, was M=467 g/mol.

### 2) Preparation of a Ketone-Aldehyde Resin (not Inventive)

176.7 g of 4-tert-butylcyclohexanone, 481.7 g of 3,3,5-trimethylcyclohexanone, 112.4 g of cyclohexanone and 373.1 g of a 30% strength by weight formalin solution were introduced as an initial charge and heated to 60° C. Thereafter 114.5 g of a 50% strength by weight sodium hydroxide solution were added dropwise over the course of 15 minutes and the mixture was heated to 80° C. Subsequently, over the course of 90 minutes, 200.0 g of the formalin solution were added dropwise and the mixture was held at reflux at 85° C. for 4 hours. The resin formed, following addition of glacial acetic acid, was washed to neutrality with water. Distillation gave a pale yellow, brittle resin having a softening point of 85° C.

### 3) Preparation of the Inventive Composition

600 g of the styrene oxide-containing polyalkylene oxide from Example 1) and 400 g of the ketone-aldehyde resin from Example 2) were mixed with one another at 80° C. with stirring. The product was clear and had a viscosity at 23° C. of 13446 mPa s.

### 4) Preparation of the Inventive Composition with Binder and Dispersing Properties

500 g of the styrene oxide-containing polyalkylene oxide from Example 1) and 500 g of the ketone-aldehyde resin from Example 2 were mixed with one another at 80° C. with stirring. The product was clear and had a viscosity at 23° C. of 88810 mPa s.

To test the effectiveness of the inventive composition as a dispersing additive with binder properties, and also that of the comparative compounds, the following procedure was adopted:

### 5) Preparation of the Pigment Preparations

For this purpose the respective additives were mixed with water and/or organic solvent and then the pigments were added. Dispersing took place, following the addition of 2 mm glass beads, in a Dispermat at 3000 rpm at 35° C. for 30 minutes. The aqueous pigment preparations were adjusted to a pH of approximately 9 using a mixture of dimethylaminoethanol and water (1:1% by weight).

### 5A) Formulation of an Aqueous, Black Pigment Preparation (Inventive)

62.9 g water
8.0 g inventive composition from Example 3)
20.0 g Special Black 4 (carbon black, Degussa AG)

This black pigment preparation was readily stirrable and foam-free.

### 5B) Formulation of an Aqueous, Black Pigment Preparation (Comparative)

70.9 g water
8.0 g noninventive compound from Example 1)
20.0 g Special Black 4 (carbon black, Degussa AG)

This black pigment preparation was highly viscous and exhibited severe foaming.

### 5C) Formulation of a Solventborne, Black Pigment Preparation (Inventive)

75.0 g butylglycol
25.0 g inventive composition from Example 4)
20.0 g Special Black 4 (carbon black, Degussa AG)

This black pigment preparation was of low viscosity.

### 5D) Formulation of an Aqueous, Blue Pigment Preparation (Inventive)

80.0 g water
20.0 g inventive composition from Example 3)

### 48.0 g Heliogen Blue L 6975F (BASF AG)

This blue pigment preparation, which had a viscosity of 58 mPa s, was readily stirrable and foam-free. It was also of unchanged stability after storage at 50° C. for more than one week.

### 5E) Formulation of an Aqueous, Blue Pigment Preparation (Comparative)

80.0 g water
20.0 g noninventive compound from Example 1)

### 48.0 g Heliogen Blue L 6975F (BASF AG)

This blue pigment preparation was highly viscous and exhibited severe foaming.

### 6) Preparation of Coating Materials from the Pigment Preparations

To prepare coating materials, the pigment preparations were introduced and the letdown compounds were added in portions.

### 6A) Preparation of Solvent-Free, Black Coating Materials

The inventive and the noninventive pigment preparations were let down with an aqueous polyurethane dispersion.

| | inventive | comparative |
|---|---|---|
| | 8.4 g from | 8.4 g from |
| Black pigment preparation | Example 5A) | Example 5B) |
| Alberdingk U 800 | 63.0 g | 63.0 g |
| (Alberdingk Boley GmbH) | | |

Drying: 1 h at 60° C., drawdown onto glass plate using 100 μm
drawing frame

| | | |
|---|---|---|
| Gloss 20° | 74 | 74 |
| Gloss 60° | 84 | 84 |
| Haze gloss | 20 | 18 |
| Pendulum hardness | 86 | 87 |

### 6B) Preparation of Solventborne and Low-Solvent, Block Coating Materials

The solventborne black pigment preparation of the invention was let down both as a solventborne system and as an aqueous system.

| | 6.8 g from | 7.0 g from |
|---|---|---|
| Black pigment preparation | Example 5C) | Example 5C) |
| Degalan 706 (Rohm GmbH) | 50.0 g | 63.0 g |
| Dynapol HW 112-56 | — | 55.5 g |
| (Degussa AG) | | |
| Cymel 325 (Cytech) | — | 3.7 g |
| Demineralized water | — | 10.0 g |
| Tego 7442, 10% in water | — | 0.8 g |
| (Tego Chemie Service | | |
| GmbH) | | |

| Drawdown onto glass plate | | Drying: 20 min at |
|---|---|---|
| using 100 μm drawing frame | Drying: 24 h at 25° C. | 140° C. |
| Gloss 20° | 73 | 92 |
| Gloss 60° | 84 | 98 |
| Haze gloss | 26 | 70-76 |
| Pendulum hardness | 141 | 175 |

### 7) Preparation of Tinted Paints

To prepare tinted varnishes the blue pigment preparation was mixed with a white paint.

The white paint consisted of 70.69 g of Alberdingk U 800 (Alberdingk Boley GmbH), 28.24 g of Kronos 2310 (Kronos Titan GmbH) and 0.07 g of Aerosil 200 (Degussa AG).

| | inventive | comparative |
|---|---|---|
| White paint | 99.0 g | 99.0 g |

| Blue pigment | | |
|---|---|---|
| preparation | 3.7 g from Example 5D) | 3.7 g from Example 5E) |
| Demineralized water | 6.5 g | 6.5 g |

The binder/white pigment ratio was 1:1 and the ratio of blue pigment to white paint 1:100.

The tinted paints drawn down, using a 100 μm drawing frame, were dried for 2 minutes and then subjected to rub-out testing. Additionally the color strength was measured.

| | Color strength F | Delta E after rub-out |
|---|---|---|
| inventive | 31 | 0.32 |
| comparative | 29 | 0.35 |

The tinted paint based on the inventive composition dried substantially more quickly than the comparative tinted paint.

Solventborne, low-solvent, and solvent-free pigment preparations and coating materials can be prepared. In contrast to the comparative examples, the aqueous pigment preparations are of low viscosity and virtually foam-free.

Furthermore, the development of color strength and the flocculation resistance of pigment preparations, and also the initial drying of coatings, were positively influenced.

1: An aqueous, solventborne or solvent-free pigment preparation essentially containing compositions comprising
A) 95% to 5% by weight of at least one block-copolymeric, styrene oxide-containing polyalkylene oxide,
and
B) 5% to 95% by weight of a ketone-aldehyde resin,
and
C) 0 to 80% by weight of at least one solvent,
the sum of the amounts by weight of components A) to C) being 100% by weight,
and
D) pigments
and
E) fillers,
and
F) 0 to 10% by weight of auxiliaries,
the amount of the sum of component A), component B), and component C) being 2%-300% by weight, based on the sum of the weights of the respective components D) and E), and it being possible for the amount of component E) in the pigment preparation also to be 0% by weight.

2: A pigment preparation as claimed in claim 1, wherein the block-copolymeric, styrene oxide-containing polyalkylene oxides A) possess the general formula I:
R¹O(SO)ₐ(EO)_{b}(PO)_{c}(BO)_{d}R²,
where R¹ is a straight-chain or branched or cycloaliphatic radical having 8 to 13 carbon atoms,
R² is hydrogen or an acryloyl radical, alkyl radical or carboxylic acid radical having in each case 1 to 8 carbon atoms,
SO=styrene oxide,
EO=ethylene oxide,
PO=propylene oxide,
BO=butylene oxide and
a=1 to 1.9,
b=3 to 50,
c=0 to 3,
d=0 to 3,
a, c or d being other than 0, and b>=a+c+d.

3: A pigment preparation as claimed in claim 1, wherein
the ketone-aldehyde resins B) contain
I. 40 to 100 mol %, based on all ketones employed, of at least one alkyl-substituted cyclohexanone having one or more alkyl radicals having 1 to 8 carbon atoms,
II. 0.8 to 2.0 mol of at least one aliphatic aldehyde, based on 1 mol of all ketones employed, and
III. 0 to 60 mol %, based on all ketones employed, of further ketones having aliphatic, cycloaliphatic, aromatic hydrocarbon radicals, it being possible for these ketones to be identical or different and to be substituted in turn, in the hydrocarbon chain, by the stated hydrocarbon radicals, and also, if desired, phenols and/or urea or its derivatives.

4: A pigment preparation as claimed in claim 1, wherein
the mixing ratio of the block-copolymeric, styrene oxide-containing polyalkylene oxides A) to the ketone-aldehyde resins B) is 95:5 to 5:95.

5: A pigment preparation as claimed in claim 1,
wherein water is present as solvent C).

6: A pigment preparation as claimed in claim 1, wherein an organic solvent is present as solvent C).

7: A composition as claimed in claim 1, wherein at least one alcohol, ester, ketone, ether, glycol ether, aromatic hydrocarbon, hydroaromatic hydrocarbon, halogenated hydrocarbon, terpene hydrocarbon, aliphatic hydrocarbon, ester alcohol, dimethylformamide or dimethyl sulfoxide, alone or in a mixture.

8: A pigment preparation as claimed in claim 1, comprising organic and/or inorganic pigments and/or carbon blacks.

9: A pigment preparation as claimed in claim 1, comprising titanium dioxides or iron oxides as inorganic pigments.

10: A pigment preparation as claimed in claim 1, comprising azo pigments, metal complex pigments, anthraquinonoid pigments, phthalocyanine pigments, polycyclic pigments, especially those of the thioindigo, quinacridone, dioxazine, pyrrolo, naphthalenetetracarboxylic acid, perylene, isoamidolin(on)e, flavanthrone, pyranthrone or isoviolanthrone series, as organic pigments.

11: A pigment preparation as claimed in claim 1, wherein gas blacks, lamp blacks or furnace blacks are used as carbon blacks.

12: A process for preparing an aqueous, solventborne or solvent-free pigment preparation essentially containing compositions comprising
A) 95% to 5% by weight of at least one block-copolymeric, styrene oxide-containing polyalkylene oxide,
and
B) 5% to 95% by weight of a ketone-aldehyde resin,
and
C) 0 to 80% by weight of at least one solvent,
the sum of the amounts by weight of components A) to C) being 100% by weight,
and
D) pigments
and
E) fillers,
and
F) 0 to 10% by weight of auxiliaries,
the amount of the sum of component A), component B), and component C) being 2%-300% by weight, based on the sum of the weights of the respective components D) and E), and it being possible for the amount of component E) in the pigment preparation also to be 0% by weight,
by mixing compounds A), B) C), D), E) and F) at temperatures from 20 to 80° C. in a Dispermat, Skandex mixer, Red Devil, single-roll mill, triple-roll mill, beadmill or other suitable assembly.

13: The method of using an aqueous, solventborne or solvent-free pigment preparation essentially containing compositions comprising
A) 95% to 5% by weight of at least one block-copolymeric, styrene oxide-containing polyalkylene oxide,
and
B) 5% to 95% by weight of a ketone-aldehyde resin,
and
C) 0 to 80% by weight of at least one solvent,
the sum of the amounts by weight of components A) to C) being 100% by weight,
and
D) pigments
and
E) fillers,
and
F) 0 to 10% by weight of auxiliaries,
the amount of the sum of component A), component B), and component C) being 2%-300% by weight, based on the sum of the weights of the respective components D) and E), and it being possible for the amount of component E) in the pigment preparation also to be 0% by weight,
in a coating material.

14: The method of using as claimed in claim 13, comprising a paint, varnish, adhesive or printing ink as coating material.
